(19) United States
(12) Patent Application Publication
(10) Pub. No.: US 2004/0069847 A1
(43) Pub. Date: Apr. 15, 2004

(54) Electronic article surveillance marker assembly

(76) Inventors: Chester Kolton, Westfield, NJ (US); Michael Norman, East Brunswick, NJ (US)

Correspondence Address: ROBIN BLECKER & DALEY, 330 MADISON AVENUE, 2ND FLOOR, NEW YORK, NY, 10017, US

(21) Appl. No.: 10/270,962

(22) Filed: Oct. 15, 2002

(51) Int. Cl. G06K 15/00

(52) U.S. Cl. 235/383

(57) ABSTRACT

An electronic article surveillance assembly comprises an elongate sheet member having a hinge section, a first panel section pivotally supported at one end of the hinge section and a second panel pivotally supported at a second end of the hinge section, an adhesive layer being disposed between and mutually securing the first and second panel sections and defining an interior compartment between the first and second panel sections, and an EAS member being secured to one of the first and second panel sections and disposed in the interior compartment, an aperture extending from the interior compartment through one of the first and second panel sections. Prior to securing the first and second panel sections, a stem of an article of manufacture is inserted through the aperture and an end of the stem is secured in place.

### FIELD OF THE INVENTION

This invention relates generally to security from shoplifting of articles of manufacture and pertains more particularly to electronic article surveillance marker assemblies for use with articles of manufacture.

### BACKGROUND OF THE INVENTION

One form of electronic article surveillance (EAS) marker in widespread use is in the form of a flat, thin, flexible, rectangular member which is applied adhesively to flat or curved exterior surfaces of articles. One shortcoming of such exterior surface application is that, while often covered by a bar code label, the presence of the EAS marker nonetheless is evident since it is visible from the sides of the bar code label. Still further, the EAS marker is accessible to a customer.

In commonly-assigned U.S. Pat. No. 5,998,462, a garment hanger is disclosed which overcomes the foregoing disadvantages. Therein, a garment hanger is set forth which is comprised of a one-piece body having a hook portion for the receipt of a display rod, a central portion depending from the hook portion and a lower portion for engagement with an article to be displayed. The central portion defines a recess opening into an exterior surface of the central portion, the recess being of dimensions suited for residence of an EAS marker in the hanger. A bar code label or like recess closure member is affixed to the central portion exterior surface in contiguous overlying relation therewith and enclosing the resident EAS marker.

### SUMMARY OF THE INVENTION

The present invention has as its primary object the provision of EAS marker assemblies having the benefit of the '462 patent and applicability to articles of manufacture other than hangers.

In attaining this and other objects, the invention provides an EAS marker assembly comprising an elongate sheet member having a hinge section, a first panel section pivotally supported at one end of the hinge section and a second panel pivotally supported at a second end of the hinge section, an adhesive layer being disposed between and mutually securing the first and second panel sections and defining an interior compartment between the first and second panel sections, and an EAS member being secured to one of the first and second panel sections and disposed in the interior compartment, at least one aperture extending from the interior compartment through one of the first and second panel sections. One of the first and second panel sections may define a hook portion distal from the hinge section.

The invention provides further, in combination, an article of manufacture having a securement shaft and a shaft detent and an electronic article surveillance assembly comprising an elongate sheet member having a hinge section, a first panel section pivotally supported at one end of the hinge section and a second panel pivotally supported at a second end of the hinge section, an adhesive layer being disposed between and mutually securing the first and second panel sections and defining an interior compartment between the first and second panel sections, and an EAS member being secured to one of the first and second panel sections and disposed in the interior compartment, at least one aperture extending from the interior compartment through one of the first and second panel sections, the securement shaft being disposed in the at least one aperture and the securement shaft detent being disposed in the interior compartment and secured with the securement shaft in the interior compartment.

In another aspect, the invention provides an electronic article surveillance assembly comprising an elongate sheet member having a first panel section, a hinge section successive to the first panel section and a second panel section successive to the hinge section, an adhesive layer having a first adhesive side secure to the first panel section and a second adhesive side, a removable layer disposed on the second adhesive side, an EAS marker secured to the first panel section transversely interiorly of the adhesive layer, the second panel section defining at least one aperture extending therethrough.

The invention will be further understood from consideration of the following description of preferred embodiments thereof and from the drawings where like reference numerals identify like parts throughout.

### DESCRIPTION OF THE DRAWINGS

FIG. 1 is a front elevation of an EAS assembly in accordance with the invention.

FIG. 2 is a right side elevation of FIG. 1.

FIG. 3 is a top plan view of FIG. 1.

FIG. 4 is a sectional view of the FIG. 1 EAS assembly as would be seen from plane IV-IV of FIG. 2.

FIG. 5 is a front elevation of the FIG. 1 EAS assembly displaying an article of manufacture.

FIG. 6 is a sectional view of FIG. 5 from the same perspective as FIG. 4.

FIG. 7 is a front elevation of a second embodiment of the invention.

FIG. 8 is a right side elevation of FIG. 7.

### DETAILED DESCRIPTION OF PREFERRED EMBODIMENTS AND PRACTICES

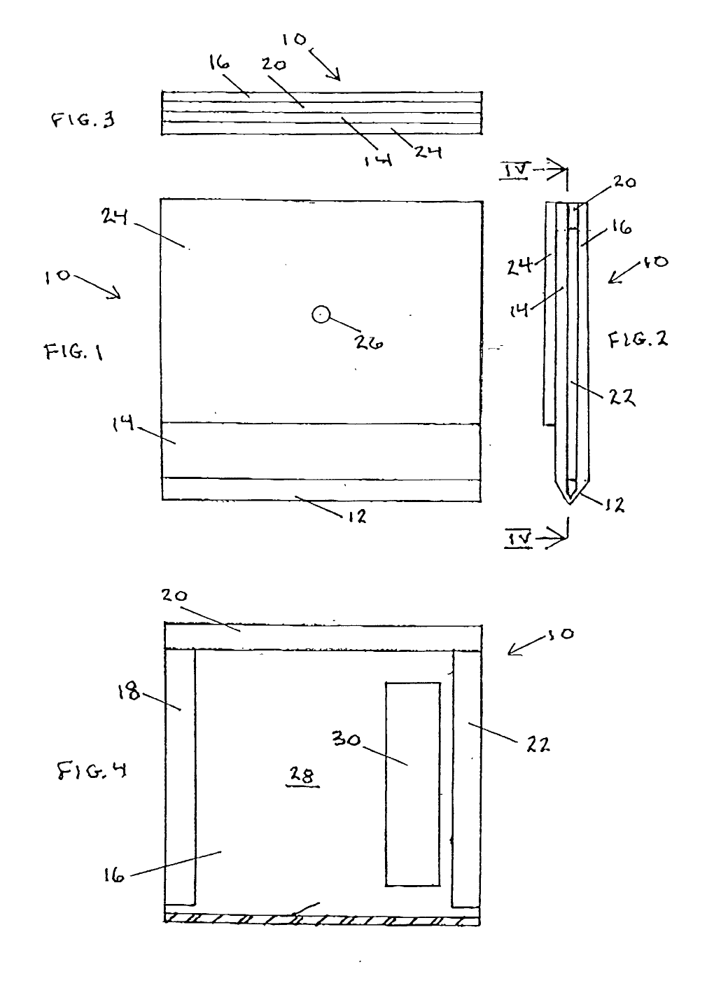

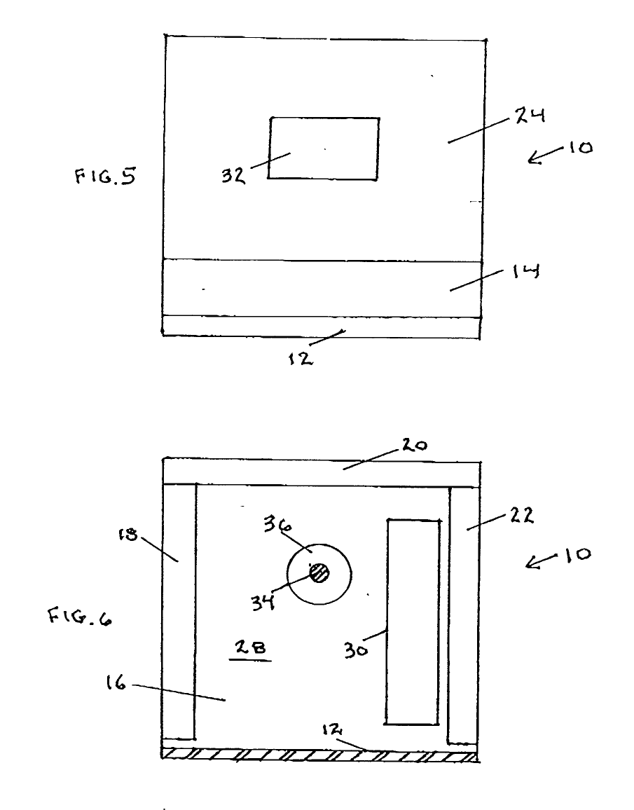

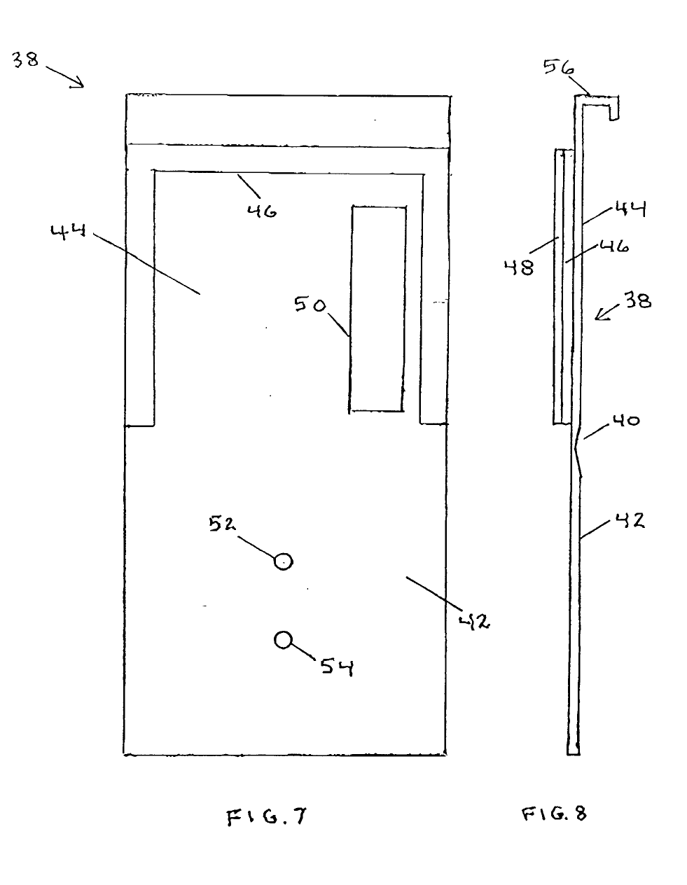

Referring to FIGS. 1-4, EAS assembly 10 includes an elongate sheet member having a hinge section 12 and panel sections 14 and 16. Adhesive layers 18, 20 and 22 are applied respectively to the inner top margin, inner right side margin and left side margin of panel section 16. The adhesive layers have adhesive on each side thereof with a removable covering on the side thereof distal from panel section 16.

A layer 24, comprised of felt or like soft material is adhesively secured to the outward side of panel section 14. Aperture 26 extends through layer 24 and panel section 14 into an interior compartment 28, bounded by adhesive layers 18, 20 and 22. An EAS marker 30 is disposed in compartment 28 aside aperture 26 and is adhesively secured to panel section 14.

In use of the described structure, panel section 14 is pivoted downwardly about hinge section 12. An article of manufacture is shown as tie pin 32 having securement shaft 34. Shaft 34 is inserted through aperture 26 into compartment 28 and shaft detent 36, i.e., the clasp used when wearing the tie pin, is lockingly engaged with the end of shaft 34.

The adhesive layer coverings are now removed and panel section 14 is folded onto adhesive layers 18, 20 and 22, thereby becoming secured to panel section 16.

Turning to FIGS. 7 and 8, EAS assembly 38 is shown in open state and includes an elongate sheet member 40 having a hinge section 42 and panel sections 44 and 46. Adhesive layer 48 is in the form of an inverted U-shape, is disposed at the side margins and the top margin of panel section 44 and, as in the case of the adhesive layers of the first embodiment, is a double-sided adhesive. A removable protective layer 50 is disposed atop adhesive layer 48. EAS marker 52 is adhesively secured to panel section 44.

Panel section 46 extends downwardly of hinge section 54, which is continuous also with panel section 44. Panel section 46 defines apertures 56 and 58.

Sheet member 40 includes a hook section 60 providing for display of the articles of manufacture, e.g., earrings, to be mounted through apertures 56 and 58.

Various changes may be introduced in the disclosed preferred embodiments without departing from the invention. By way of example, the three adhesive layers of the first embodiment, shown as disposed on one of the two panel sections, may be disposed on the other panel section or arranged two on one panel section and the other on the other panel section. Likewise, the EAS marker may be secured to either of the panel sections. Accordingly, it is to be appreciated that the true spirit and scope of the invention is set forth in the following claims

What is claimed is:

1. An electronic article surveillance assembly comprising an elongate sheet member having a hinge section, a first panel section pivotally supported at one end of said hinge section and a second panel pivotally supported at a second end of said hinge section, an adhesive layer being disposed between and mutually securing said first and second panel sections and defining an interior compartment between said first and second panel sections, and an EAS member being secured to one of said first and second panel sections and disposed in said interior compartment, at least one aperture extending from said interior compartment through one of said first and second panel sections.

2. The electronic article surveillance assembly claimed in claim 1, wherein one of said first and second panel sections defines a hook portion distal from said hinge section.

3. The electronic article surveillance assembly claimed in claim 1, wherein said at least one aperture extends into said interior compartment to a location distal from said EAS marker.

4. The electronic article surveillance assembly claimed in claim 1, further including a layer secured to an outward side on one of said first and second panel sections and defining a further at least one aperture in registry with said at least one aperture.

5. In combination:
(a) an article of manufacture having a securement shaft and a shaft detent; and
(b) an electronic article surveillance assembly comprising an elongate sheet member having a hinge section, a first panel section pivotally supported at one end of said hinge section and a second panel pivotally supported at a second end of said hinge section, an adhesive layer being disposed between and mutually securing said first and second panel sections and defining an interior compartment between said first and second panel sections, and an EAS member being secured to one of said first and second panel sections and disposed in said interior compartment, at least one aperture extending from said interior compartment through one of said first and second panel sections,
said securement shaft being disposed in said at least one aperture,
said securement shaft detent being disposed in said interior compartment and secured with said securement shaft in said interior compartment.

6. The invention claimed in claim 5, wherein one of said first and second panel sections defines a hook portion distal from said hinge section.

7. The invention claimed in claim 5, wherein said at least one aperture extends into said interior compartment to a location distal from said EAS marker.

8. The invention claimed in claim 5, further including a layer secured to an outward side on one of said first and second panel sections and defining a further at least one aperture in registry with said at least one aperture.

9. An electronic article surveillance assembly comprising an elongate sheet member having a first panel section, a hinge section successive to said first panel section and a second panel section successive to said hinge section, an adhesive layer having a first adhesive side secure to said first panel section and a second adhesive side, a removable layer disposed on said second adhesive side, an EAS marker secured to said first panel section transversely interiorly of said adhesive layer, said second panel section defining at least one aperture extending therethrough.

10. The electronic article surveillance assembly claimed in claim 9, wherein one of said first and second panel sections defines a hook portion distal from said hinge section.

11. The invention claimed in claim 9, further including a layer secured to an outward side of said second panel section and defining a further at least one aperture in registry with said at least one aperture.
